(19) United States
(12) Patent Application Publication
(10) Pub. No.: US 2026/0201944 A1
(43) Pub. Date: Jul. 16, 2026

(54) DIFFERENTIAL DEVICE FOR VEHICLE

(71) Applicant: JTEKT CORPORATION, Kariya-shi (JP)

(72) Inventors: Kenji ASAMI, Kariya-shi (JP); Kenji KUSHIZAKI, Kariya-shi (JP); Takuya TSUDA, Kariya-shi (JP); Ryouya TSUJI, Kariya-shi (JP)

(73) Assignee: JTEKT CORPORATION, Kariya-shi (JP)

(21) Appl. No.: 19/109,616

(22) PCT Filed: Sep. 14, 2022
(86) PCT No.: PCT/JP2022/034463

§ 371 Date: Mar. 7, 2025

(51) Int. Cl. F16H 48/06; F16H 48/38

(52) U.S. Cl. CPC F16H 48/06; F16H 48/38; F16H 2048/387

(57) ABSTRACT

A vehicle differential device includes a pinion gear pair, a first side gear pair, a second side gear pair, a differential case, a first sliding member, a second sliding member, a third sliding member, and an elastic member. The elastic member is compressed in the rotation axis direction by the first outer gear member and the second outer gear member, or the first inner gear member and the second inner gear member, both during driving, which is when torque in a forward direction of the vehicle is input to the differential case, and during coasting, which is when the vehicle is traveling forward under inertia, and the first sliding member and the second sliding member are restricted from rotating relative to the differential case, and are also movable relative to the differential case in the rotation axis direction.

### TECHNICAL FIELD

The present disclosure relates to a differential device for a vehicle that has a differential limiting function.

### BACKGROUND ART

Some differential devices that distribute driving force from a drive source of a vehicle to a right wheel and a left wheel while allowing differential motion have a differential limiting function that limits differential rotation between the right wheel and the left wheel. When one wheel of the right wheel and the left wheel slips, for example, such a differential device can transmit driving force to the other wheel, and can improve driving stability.

A differential device described in PTL 1 includes a plurality of planetary gear pairs, each of which is formed by a pair of planetary gears meshing, a first sun gear that meshes with one planetary gear of the pair of planetary gears, a second sun gear that meshes with the other planetary gear of the pair of planetary gears, and a differential case (housing) that accommodates these. The differential case has a cylindrical part having retaining holes that are formed therein for retaining the plurality of planetary gear pairs, and first and second side wall parts that are formed so as to close off both end parts of the cylindrical part. The first and second sun gears are disposed arrayed in an axial direction between a first side wall part and a second side wall part. Washers are each disposed between the first sun gear and the first side wall part, between the second sun gear and the second side wall part, and between the first sun gear and the second sun gear.

The first and second sun gears are divided into an outer portion and an inner portion at substantially middle part thereof in a radial direction, and a spline part that is formed on an outer periphery of the inner portion is spline fitted with a spline hole that is formed on an inner periphery of the outer portion. Due to this spline fitting, when torque is transmitted to the right wheel and the left wheel, thrust forces in directions opposite to each other are generated between the outer portion and inner portion, and axial-direction end faces of each of the outer portion and the inner portion are pressed against the washer. Frictional force between the axial-direction end faces and the washer increases differential limit force.

### CITATION LIST

### Patent Literature

PTL 1: JP 2009-174577 A

### BRIEF SUMMARY

### Technical Problem

When driving in conditions in which great differential limit force is frequently generated, such as when driving uphill on muddy roads or gravel roads for example, the gears in the differential case may expand due to frictional heat, causing axial lengths thereof in the axial direction to increase. In such a case, when thermal expansion of one of the gears in the differential case causes both axial-direction end faces of the gear to be pressed against the washers, the differential limit force may become greater than force that is generated by the thrust force in the axial direction. Also, increasing clearance (play) between the gears and the washers in the axial direction in the differential case, in order to keep thrust force due to such thermal expansion of the gears from increasing, may reduce responsiveness of the differential limit force when wheel slippage or the like occurs.

Accordingly, an object of the present disclosure is to provide a vehicle differential device that can suppress increase in differential limit force due to thermal expansion of gears in a differential case, while suppressing decrease in responsiveness of the differential limit force.

### Solution to Problem

In order to achieve the above object, the present disclosure provides a vehicle differential device including a pinion gear pair including a first pinion gear and a second pinion gear that have helical teeth of which tooth traces are inclined with respect to an axial direction, and that are meshed with each other, a first side gear pair including a first outer gear member that has a cylindrical shape and that meshes with the first pinion gear, and a first inner gear member that is disposed on an inner side of the first outer gear member, the first outer gear member and the first inner gear member being helically spline fitted with each other, a second side gear pair including a second outer gear member that has a cylindrical shape and that meshes with the second pinion gear, and a second inner gear member that is disposed on an inner side of the second outer gear member, the second outer gear member and the second inner gear member being helically spline fitted with each other, a differential case that includes a cylindrical part in which a retaining hole for rotatably accommodating the first pinion gear and the second pinion gear is formed, and first and second side wall parts, a first sliding member that is disposed between the first side gear pair and the first side wall part, a second sliding member that is disposed between the second side gear pair and the second side wall part, a third sliding member that is disposed between the first side gear pair and the second side gear pair, and an elastic member that is disposed arrayed with any one of the first to third sliding members, between the first side wall part and the second side wall part within the differential case in a rotation axis direction of the differential case, and that is elastically deformable in the rotation axis direction, in which the elastic member is compressed in the rotation axis direction by the first outer gear member and the second outer gear member, or the first inner gear member and the second inner gear member, both during driving, which is when torque in a forward direction of the vehicle is input to the differential case, and during coasting, which is when the vehicle is traveling forward under inertia, and the first sliding member and the second sliding member are restricted from rotating relative to the differential case, and are also movable relative to the differential case in the rotation axis direction.

### Advantageous Effects

According to the vehicle differential device of the present disclosure, increase in the differential limit force due to thermal expansion of the gears in the differential case can be suppressed, while suppressing decrease in the responsiveness of the differential limit force.

### BRIEF DESCRIPTION OF DRAWINGS

FIG. 1 is a cross-sectional view illustrating an example of a configuration of a vehicle differential device according to a first embodiment of the present disclosure.

FIG. 2 is a cross-sectional view taken along line A-A of FIG. 1.

FIG. 3 is a disassembled perspective view of the vehicle differential device.

FIG. 4A is a cross-sectional view of part of the vehicle differential device, during driving at normal temperature.

(FIG. 4B) FIG. 4B is a cross-sectional view of part of the vehicle differential device, during driving at high temperature.

FIG. 5A is a cross-sectional view of part of the vehicle differential device, during coasting at normal temperature.

FIG. 5B is a cross-sectional view of part of the vehicle differential device, during coasting at high temperature.

FIG. 6A is a cross-sectional view of part of a vehicle differential device according to a comparative example, during driving at normal temperature.

FIG. 6B is a cross-sectional view of part of the vehicle differential device according to the comparative example, during driving at high temperature.

FIG. 7 is a cross-sectional view of a vehicle differential device according to a second embodiment.

FIG. 8A is a cross-sectional view of part of the vehicle differential device according to the second embodiment, during driving at normal temperature.

FIG. 8B is a cross-sectional view of part of the vehicle differential device according to the second embodiment, during driving at high temperature.

### DESCRIPTION OF EMBODIMENTS

### First Embodiment

A first embodiment of the present disclosure will be described with reference to the drawings. Note that the embodiment described below is given as a suitable specific example for carrying out the present disclosure, and while there are portions exemplifying various technically preferable technical matters in detail, the technical scope of the present invention disclosure is not limited to such specific aspects.

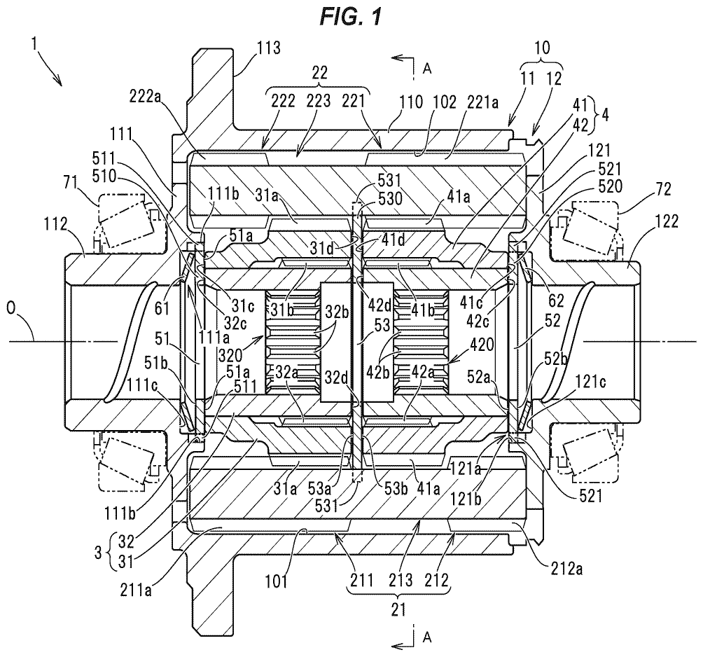

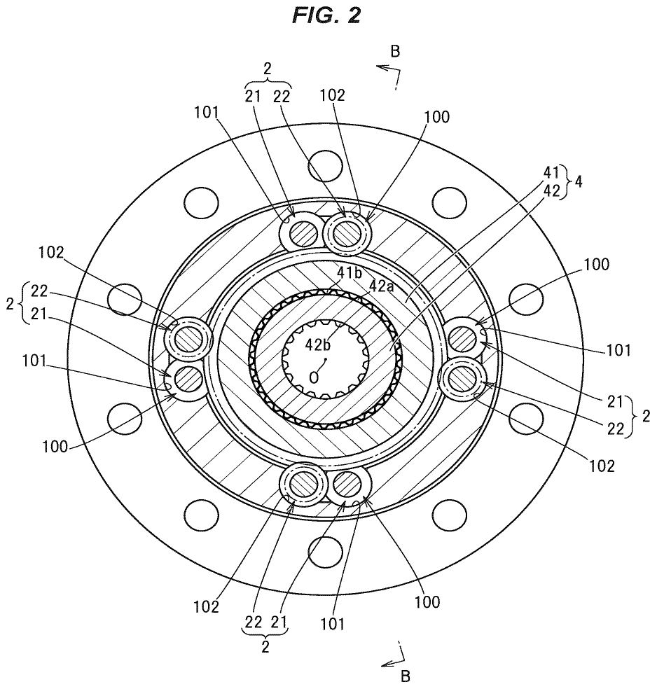

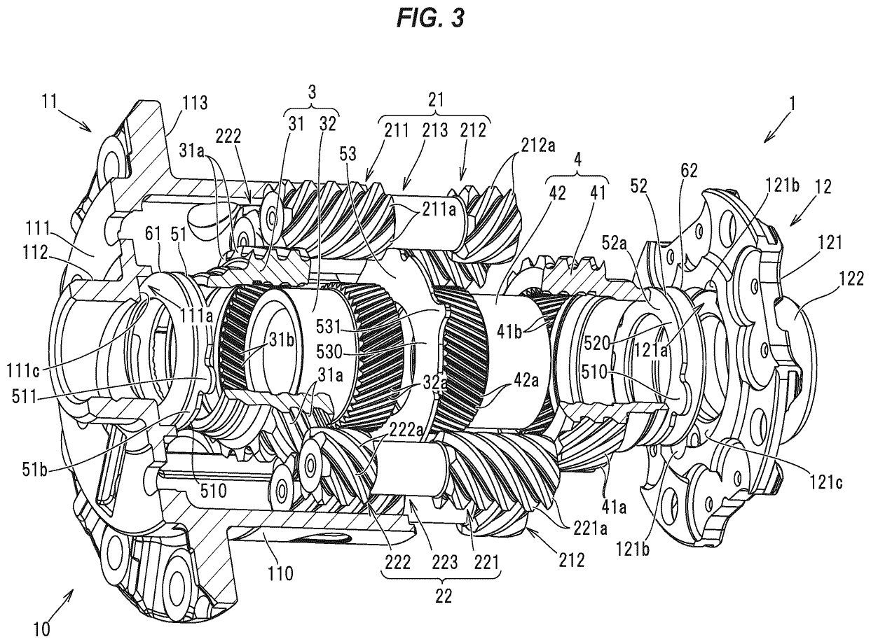

FIG. 1 is a cross-sectional view illustrating an example of a configuration of a vehicle differential device 1 according to the first embodiment of the present disclosure. FIG. 2 is a cross-sectional view taken along line A-A of FIG. 1. FIG. 3 is a disassembled perspective view of the vehicle differential device 1. FIG. 1 illustrates a cross-section taken along line B-B in FIG. 2, on a rotation axis of the vehicle differential device 1.

This vehicle differential device 1 is used to distribute driving force of a drive source of a vehicle to a pair of output shafts while allowing differential motion. An engine or an electric motor may be used as the drive source. The vehicle differential device 1 according to the present embodiment is used as a differential device that distributes the driving force of the drive source to right and left drive wheels, and distributes the driving force that is input thereto to right and left drive shafts serving as the pair of output shafts.

The vehicle differential device 1 includes a differential case 10 to which driving force of the drive source is input, a plurality of pinion gear pairs 2 that is retained in the differential case 10, first and second side gear pairs 3 and 4 that are disposed on an inner side of the plurality of pinion gear pairs 2 within the differential case 10, a first end washer 51 serving as a first sliding member, a second end washer 52 serving as a second sliding member, a center washer 53 serving as a third sliding member, and first and second disc springs 61 and 62 serving as elastic members.

The differential case 10 has a differential case body 11 that has a cylindrical shape with a bottom, and a differential case lid 12 that is disposed so as to cover an opening of the differential case body 11. The differential case body 11 integrally has a cylindrical part 110 that has a cylindrical shape, a first side wall part 111 that is formed so as to cover an end part on one side of the cylindrical part 110 in an axial direction thereof, an extending part 112 that has a cylindrical shape and that extends outward from a center part of the first side wall part 111, and a flange part 113 that is formed so as to flare outward from an outer peripheral face of the cylindrical part 110. A ring gear that is omitted from illustration is fixed to the flange part 113, and the driving force of the drive source is transmitted from this ring gear to the differential case 10. The differential case 10 rotates about a rotation axial line O under the driving force that is input thereto. Hereinafter, a direction that is parallel to the rotation axial line O will be referred to as a rotation axis direction.

The differential case lid 12 integrally has a second side wall part 121 that has a disc-like shape, and an extending part 122 that has a cylindrical shape extending outward from a center part of the second side wall part 121. An end part on an outer peripheral side of the second side wall part 121 is fixed by welding, for example, to an end part of the cylindrical part 110 of the differential case body 11 opposite the first side wall part 111.

In FIG. 1, first and second bearings 71 and 72 that support the differential case 10 are indicated in hidden outline (long dashed double-short dashed lines). The differential case 10 is rotatably supported relative to a differential carrier that is omitted from illustration, by the first bearing 71 that is fitted onto the extending part 112 of the differential case body 11 and the second bearing 72 that is fitted onto the extending part 122 of the differential case lid 12. The first bearing 71 and the second bearing 72 are tapered roller bearings to which a preload in the axial direction is applied.

In this embodiment, as shown in FIG. 2, four pinion gear pairs 2 are held in respective retaining holes 100 that are formed in the cylindrical part 110 of the differential case 10. Each pinion gear pair 2 has a first pinion gear 21 and a second pinion gear 22, and the first pinion gear 21 and the second pinion gear 22 mesh with each other. Each retaining hole 100 has a first hole part 101 that retains the first pinion gear 21 and a second hole part 102 that retains the second pinion gear 22, and the first hole part 101 and the second hole part 102 are in communication with each other. The first hole part 101 and the second hole part 102 open inward in the cylindrical part 110.

The first pinion gear 21 integrally has a long gear part 211 and a short gear part 212 which have different lengths as to each other in the axial direction, and a linking part 213 which connects the long gear part 211 and the short gear part 212 in the axial direction. A plurality of helical teeth 211a and 212a, of which tooth traces are inclined with respect to the axial direction, is formed on outer perimeters of the long gear part 211 and the short gear part 212, respectively. In the same way, the second pinion gear 22 integrally has a long gear part 221 and a short gear part 222 that have different lengths as to each other in the axial direction, and a linking part 223 that links the long gear part 221 and the short gear part 222 in the axial direction. A plurality of helical teeth 221a and 222a, of which tooth traces are inclined with respect to the axial direction, is formed on the outer perimeters of the long gear part 221 and the short gear part 222, respectively.

The short gear part 212 of the first pinion gear 21 meshes with part of the long gear part 221 of the second pinion gear 22. Also, the short gear part 222 of the second pinion gear 22 meshes with part of the long gear part 211 of the first pinion gear 21.

The first side gear pair 3 has a first outer gear member 31 that has a cylindrical shape and that meshes with the first pinion gear 21, and a first inner gear member 32 that is disposed on an inner side of the first outer gear member 31. The first outer gear member 31 meshes with part of the long gear part 211 of the first pinion gear 21. The first outer gear member 31 has a plurality of helical teeth 31a that is formed on an outer perimeter thereof, the helical teeth 31a being inclined with respect to the axial direction, and these helical teeth 31a meshing with the helical teeth 211a of the long gear part 211 of the first pinion gear 21. That is to say, the long gear part 211 of the first pinion gear 21 at one part thereof meshes with the short gear part 222 of the second pinion gear 22, and at another part thereof meshes with the first outer gear member 31.

The first outer gear member 31 and the first inner gear member 32 are helically spline fitted. Helical spline teeth 31b that are inclined with respect to the axial direction are formed on an inner perimeter of the first outer gear member 31, and these helical spline teeth 31b mesh with helical spline teeth 32a that are formed on an outer perimeter of the first inner gear member 32. A straight spline fitting part 320 that is made up of a plurality of spline teeth 32b extending parallel to the rotation axial line O is formed on an inner perimeter of the first inner gear member 32. One end part of a drive shaft that transmits driving force to a left front wheel of the vehicle, for example, is linked to this straight spline fitting part 320 so as to be incapable of relative rotation.

The second side gear pair 4 has a second outer gear member 41 that has a cylindrical shape and that meshes with the second pinion gear 22, and a second inner gear member 42 that is disposed on an inner side of the second outer gear member 41. The second outer gear member 41 meshes with part of the long gear part 221 of the second pinion gear 22. The second outer gear member 41 has a plurality of helical teeth 41a that is formed on the outer perimeter thereof, the helical teeth 41a being inclined with respect to the axial direction, and these helical teeth 41a mesh with the helical teeth 221a of the long gear part 221 of the second pinion gear 22. That is to say, the long gear part 221 of the second pinion gear 22 at one part thereof meshes with the short gear part 212 of the first pinion gear 21, and at another part thereof meshes with the second outer gear member 41.

The second outer gear member 41 and the second inner gear member 42 are helically spline fitted. Helical spline teeth 41b that are inclined with respect to the axial direction are formed on an inner perimeter of the second outer gear member 41, and these helical spline teeth 41b mesh with helical spline teeth 42a that are formed on an outer perimeter of the second inner gear member 42. A straight spline fitting part 420 that is made up of a plurality of spline teeth 42b extending parallel to the rotation axial line O is formed on an inner perimeter of the second inner gear member 42. One end part of the drive shaft that transmits driving force to a right front wheel of the vehicle, for example, is linked to this straight spline fitting part 420 so as to be incapable of relative rotation.

The first end washer 51, the second end washer 52, and the center washer 53 are metal members that have a flat plate form and that have a predetermined thickness in the rotation axis direction of the differential case 10. The first end washer 51 is disposed between the first side gear pair 3 and the first side wall part 111 of the differential case 10. The second end washer 52 is disposed between the second side gear pair 4 and the second side wall part 121 of the differential case 10. The center washer 53 is disposed between the first side gear pair 3 and the second side gear pair 4.

The first end washer 51 is accommodated in a recess 111a that is formed in the first side wall part 111 of the differential case 10, and is movable relative to the differential case 10 in the rotation axis direction within the recess 111a. The first end washer 51 integrally has a body part 510 that has an annular shape and a plurality of projections 511 that is formed projecting outward from the body part 510. Parts of the recess 111a protrude to an outer perimeter side to form rotation stoppers 111b, and the projections 511 fit to these rotation stoppers 111b, thereby restricting the relative rotation of the first end washer 51 with respect to the differential case 10.

The second end washer 52 is accommodated in a recess 121a formed in the second side wall part 121 of the differential case 10, and is movable relative to the differential case 10 in the rotation axis direction within the recess 111a. The second end washer 52 integrally has a body part 520 that has an annular shape and a plurality of projections 521 that is formed projecting outward from the body part 520. Parts of the recess 121a protrude to an outer perimeter side to form rotation stoppers 121b, and the projections 521 fit to these rotation stoppers 121b, thereby restricting the relative rotation of the second end washer 52 with respect to the differential case 10.

The center washer 53 has a body part 530 that has an annular shape and a plurality of projections 531 that is formed projecting outward from the body part 530. The plurality of projections 531 of the center washer 53 is engaged between the linking parts 213 and 223 of the first and second pinion gears 21 and 22, respectively, whereby relative rotation with respect to the differential case 10 is restricted, and also the center washer 53 is movable relative to the differential case 10 in the rotation axis direction.

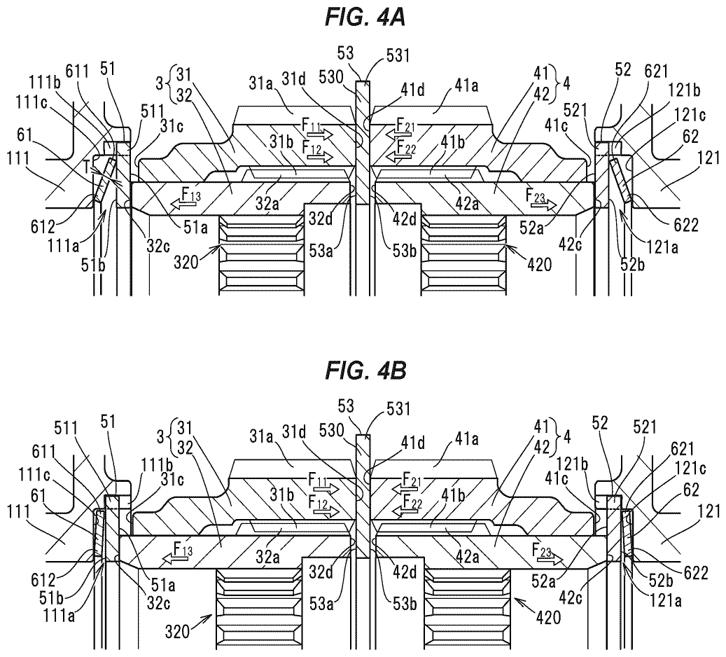

FIG. 4A and FIG. 4B are cross-sectional views illustrating the first side wall part 111 and the second side wall part 121, and the first and second side gear pairs 3 and 4, the first and second end washers 51 and 52 and the center washer 53, and the first and second disc springs 61 and 62 that are disposed between the first side wall part 111 and the second side wall part 121, when torque in a forward direction of the vehicle is input to the differential case 10 of the vehicle differential device 1 (during driving).

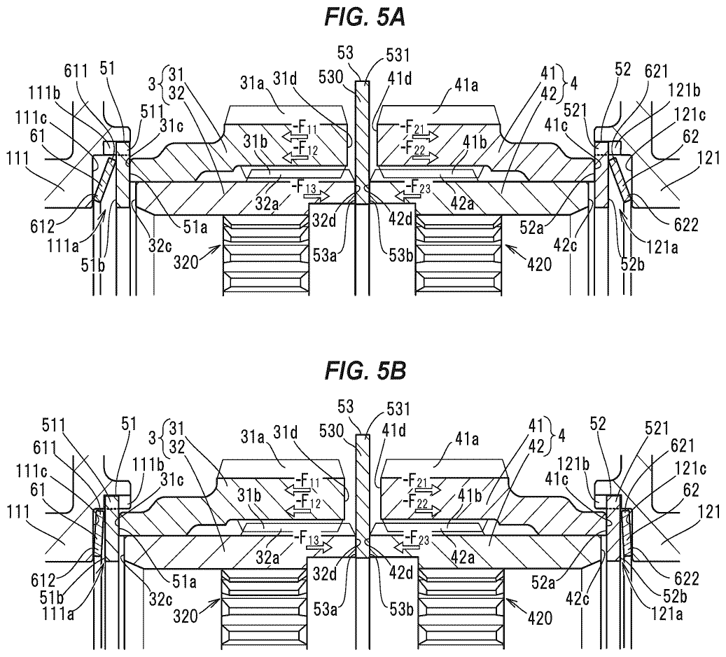

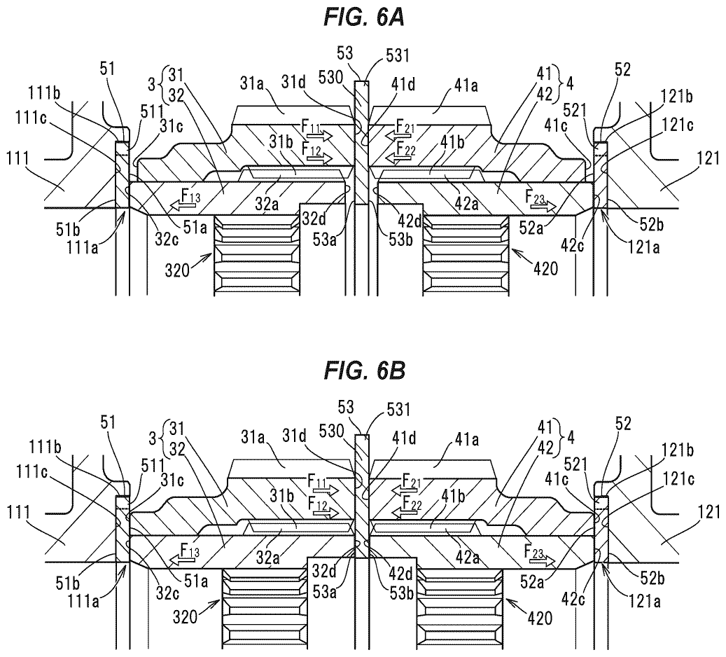

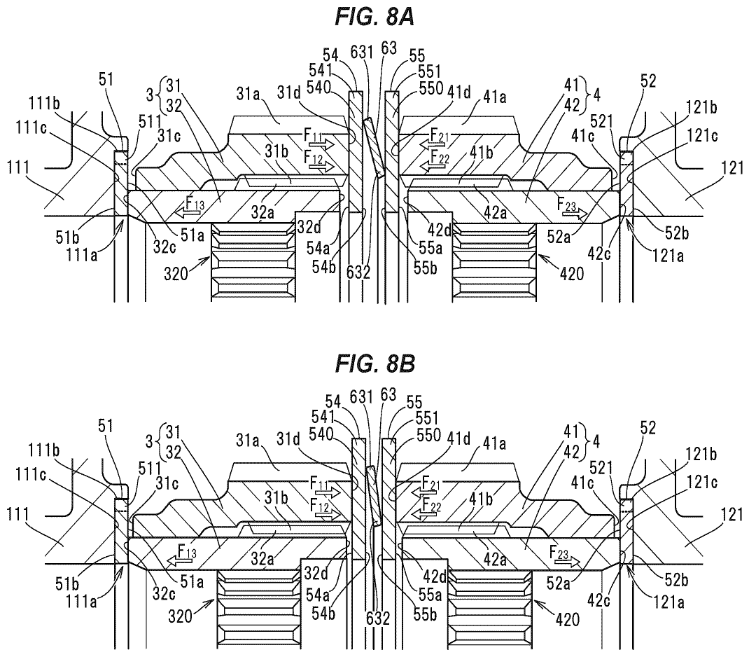

FIG. 4A illustrates the first outer gear member 31 and the first inner gear member 32 of the first side gear pair 3, and the second outer gear member 41 and the second inner gear member 42 of the second side gear pair 4, in a state of normal temperature. FIG. 4B illustrates a state in which the first outer gear member 31 and the first inner gear member 32 of the first side gear pair 3, and the second outer gear member 41 and the second inner gear member 42 of the second side gear pair 4 have thermally expanded, and lengths thereof in the axial direction have become longer than at normal temperature. Note that in FIG. 4A and FIG. 4B, as well as in FIG. 5A and FIG. 5B, FIG. 6A and FIG. 6B, and FIG. 8A and FIG. 8B, which will be described below, the amount of thermal expansion of each gear member is illustrated in an exaggerated manner, for clarity of description.

One face of the first end washer 51 in the rotation axis direction of the differential case 10 is a sliding face 51a that frictionally slides against an axial-direction end face 31c on the first side wall part 111 side of the first outer gear member 31 and an axial-direction end face 32c on the first side wall part 111 side of the first inner gear member 32. The other face of the first end washer 51 in the rotation axis direction of the differential case 10, which is the rear face from the sliding face 51a, is an abutting face 51b that abuts the first disc spring 61. The first disc spring 61 is disposed between the abutting face 51b of the first end washer 51 and the first side wall part 111.

The first disc spring 61 is accommodated in the recess 111a of the first side wall part 111 along with the first end washer 51, and is arrayed adjacent to the first end washer 51 in the rotation axis direction of the differential case 10. The first disc spring 61 is elastically deformable in the rotation axis direction of the differential case 10, with one end part 611 thereof in the rotation axis direction abutting against the abutting face 51b of the first end washer 51 and another end part 612 thereof in the rotation axis direction abutting a bottom face 111c of the recess 111a. The first end washer 51 is pressed in the rotation axis direction of the differential case 10, toward the first side gear pair 3, by restoring force of the first disc spring 61.

One face of the second end washer 52 in the rotation axis direction of the differential case 10 is a sliding face 52a that frictionally slides against an axial-direction end face 41c on the first side wall part 111 side of the second outer gear member 41 and an axial-direction end face 42c on the second side wall part 121 side of the second inner gear member 42. The other face of the second end washer 52 in the rotation axis direction of the differential case 10, which is the rear face of the sliding face 52a, is an abutting face 52b that abuts the second disc spring 62. The second disc spring 62 is disposed between the abutting face 52b of the second end washer 52 and the second side wall part 121.

The second disc spring 62 is accommodated in the recess 121a of the second side wall part 121 along with the second end washer 52, and is arrayed adjacent to the second end washer 52 in the rotation axis direction of the differential case 10. The second disc spring 62 is elastically deformable in the rotation axis direction of the differential case 10, with one end part 621 thereof in the rotation axis direction abutting against the abutting face 52b of the second end washer 52 and another end part 622 thereof in the rotation axis direction abutting a bottom face 121c of the recess 121a. The second end washer 52 is pressed in the rotation axis direction of the differential case 10, toward the second side gear pair 4, by restoring force of the second disc spring 62.

In FIG. 4A and FIG. 4B, thrust forces in the rotation axis direction of the differential case 10 that are received by the first outer gear member 31, the first inner gear member 32, the second outer gear member 41, and the second inner gear member 42, when torque is transmitted by the vehicle differential device 1, are indicated by arrows F₁₁, F₁₂, F₁₃, F₂₁, F₂₂, and F₂₃. The direction of each arrow indicates the direction of the thrust force.

F₁₁ is thrust force that the first outer gear member 31 receives by meshing with the first pinion gear 21. F₁₂ is thrust force that the first outer gear member 31 receives from the helical spline fitting with the first inner gear member 32. F₁₃ is thrust force that the first inner gear member 32 receives from the helical spline fitting with the first outer gear member 31, as a reaction force to F₁₂.

F₂₁ is thrust force that the second outer gear member 41 receives by meshing with the second pinion gear 22. F₂₂ is thrust force that the second outer gear member 41 receives from the helical spline fitting with the second inner gear member 42. F₂₃ is thrust force that the second inner gear member 42 receives from the helical spline fitting with the second outer gear member 41, as a reaction force to F₂₂.

An axial-direction end face 31d on the center washer 53 side of the first outer gear member 31 is pressed against a first sliding face 53a of the center washer 53 by thrust forces F₁₁ and F₁₂, and receives frictional resistance force from the center washer 53. The axial-direction end face 32c on the first side wall part 111 side of the first inner gear member 32 is pressed against the sliding face 51a of the first end washer 51 by thrust force F₁₃, and receives frictional resistance force from the first end washer 51.

An axial-direction end face 41d on the center washer 53 side of the second outer gear member 41 is pressed against a second sliding face 53b of the center washer 53 by thrust forces F₂₁ and F₂₂, and receives frictional resistance force from the center washer 53. An axial-direction end face 42c on the second side wall part 121 side of the second inner gear member 42 is pressed against the sliding face 52a of the second end washer 52 by thrust force F₂₃, and receives frictional resistance force from the second end washer 52.

The frictional resistance force that the first outer gear member 31 and the second outer gear member 41 receive from the center washer 53, the frictional resistance force that the first inner gear member 32 receives from the first end washer 51, and the frictional resistance force that the second inner gear member 42 receives from the second end washer 52, act as differential limit forces that limit the differential rotation of the right and left wheels during driving.

FIG. 5A and FIG. 5B are cross-sectional views illustrating the first side wall part 111, the second side wall part 121, the first and second side gear pairs 3 and 4, the first and second end washers 51 and 52 and the center washer 53, and the first and second disc springs 61 and 62, when torque is transmitted from the right and left wheel sides to the differential case 10 when the vehicle is traveling forward under inertia (during coasting).

FIG. 5A illustrates the gear members at normal temperature, and FIG. 5B illustrates the gear members in a state in which the lengths thereof in the axial direction have become longer than at normal temperature due to thermal expansion.

During coasting, thrust forces acts on the first outer gear member 31, the first inner gear member 32, the second outer gear member 41, and the second inner gear member 42, in directions opposite to those during driving. In FIG. 5A and FIG. 5B, these thrust forces are indicated by arrows -F₁₁, -F₁₂, -F₁₃, -F₂₁, -F₂₂, and -F₂₃.

Due to these thrust forces, the axial-direction end face 31c on the first side wall part 111 side of the first outer gear member 31 is pressed against the sliding face 51a of the first end washer 51, and an axial-direction end face 32d on the center washer 53 side of the first inner gear member 32 is pressed against the first sliding face 53a of the center washer 53. Also, the axial-direction end face 41c on the second side wall part 121 side of the second outer gear member 41 is pressed against the sliding face 52a of the second end washer 52, and an axial-direction end face 42d on the center washer 53 side of the second inner gear member 42 is pressed against the second sliding face 53b of the center washer 53. The frictional resistance force that is generated thereby acts as a differential limit force that limits the differential rotation of the right and left wheels during coasting.

The first disc spring 61 is compressed in the axial direction by thrust force F₁₃ during driving, and also by thrust forces -F₁₁ and -F₁₂ during coasting. In conjunction with the first disc spring 61 being compressed, the first end washer 51 is displaced toward the bottom face 111c side in the recess 111a of the first side wall part 111. Accordingly, during driving, either at normal temperature as illustrated in FIG. 4A or at high temperature as illustrated in FIG. 4B, the axial-direction end face 31c of the first outer gear member 31 does not come into contact with the sliding face 51a of the first end washer 51, and the axial-direction end face 32d of the first inner gear member 32 does not come into contact with the first sliding face 53a of the center washer 53. Also, during coasting, either at normal temperature as illustrated in FIG. 5A or at high temperature as illustrated in FIG. 5B, the axial-direction end face 31d of the first outer gear member 31 does not come into contact with the first sliding face 53a of the center washer 53, and the axial-direction end face 32c of the first inner gear member 32 does not come into contact with the sliding face 51a of the first end washer 51.

The second disc spring 62 is compressed in the axial direction by thrust force F₂₃ during driving, and also by thrust forces -F₂₁ and -F₂₂ during coasting. In conjunction with the second disc spring 62 being compressed, the second end washer 52 is displaced toward the bottom face 121c side in the recess 121a of the second side wall part 121. Accordingly, during driving, either at normal temperature as illustrated in FIG. 4A or at high temperature as illustrated in FIG. 4B, the axial-direction end face 41c of the second outer gear member 41 does not come into contact with the sliding face 52a of the second end washer 52, and the axial-direction end face 42d of the second inner gear member 42 does not come into contact with the second sliding face 53b of the center washer 53. Also, during coasting, either at normal temperature as illustrated in FIG. 5A or at high temperature as illustrated in FIG. 5B, the axial-direction end face 41d of the second outer gear member 41 does not come into contact with the second sliding face 53b of the center washer 53, and the axial-direction end face 42c of the second inner gear member 42 does not come into contact with the sliding face 52a of the second end washer 52.

Thus, in the present embodiment, even when the first outer gear member 31, the first inner gear member 32, the second outer gear member 41, and the second inner gear member 42 thermally expand, the first disc spring 61 and the second disc spring 62 absorb the amount of thermal expansion thereof, and both end faces of these gear members in the axial direction do not come into contact with the center washer 53 and the first end washer 51 or the second end washer 52 at the same time. Thus, increase in the differential limiting force due to thermal expansion of these gear members can be suppressed.

Also, even when the depths of the recesses 111a and 121a in the axial direction are increased to absorb this thermal expansion and increase a stroke distance over which the first end washer 51 and the second end washer 52 can move in an axial line direction, the first end washer 51 and the second end washer 52 are biased in the rotation axial line direction of the differential case 10 by the first disc spring 61 and the second disc spring 62, respectively, and accordingly decrease in the responsiveness of the differential limit force can be suppressed. That is to say, according to the present embodiment, increase in the differential limit force due to thermal expansion of the gears in the differential case can be suppressed, while suppressing decrease in the responsiveness of the differential limit force.

### Comparative Example

FIG. 6A and FIG. 6B are cross-sectional views illustrating, as a comparative example, a configuration of a vehicle differential device that does not have the first disc spring 61 and the second disc spring 62. FIG. 6A illustrates a state during driving at normal temperature, and FIG. 6B illustrates a state during driving at high temperature.

In this comparative example, when the first outer gear member 31 and the second outer gear member 41 become hot and exhibit thermal expansion, and the lengths thereof in the axial direction increase, both end faces 31c and 31d of the first outer gear member 31 in the axial direction abut the first end washer 51 and the center washer 53 respectively, and both end faces 41c and 41d of the second outer gear member 41 in the axial direction abut the second end washer 52 and the center washer 53 respectively, as illustrated in FIG. 6B. When clearances between the first outer gear member 31 and the second outer gear member 41 and the washers 51 to 53, between the first side wall part 111 and the second side wall part 121, become narrow in this way, frictional force therebetween increases, and the differential limit force rapidly increases.

Also, when the first inner gear member 32 and the second inner gear member 42 exhibit thermal expansion and the axial lengths thereof increase, as illustrated in FIG. 6B, both end faces 32c and 32d of the first inner gear member 32 in the axial direction abut the first end washer 51 and the center washer 53 respectively, and both end faces 42c and 42d of the second inner gear member 42 in the axial direction abut the second end washer 52 and the center washer 53 respectively. When clearances between the first inner gear member 32 and the second inner gear member 42 and the washers 51 to 53, between the first side wall part 111 and the second side wall part 121, become narrow in this way, frictional force therebetween increases, and the differential limit force rapidly increases.

Also, in a case of increasing the clearances between the gear members and the washers 51 to 53 so that the clearances do not become closed off even when the gear members become thermally expanded in this way, the amount of movement of the gear members in the axial direction before frictional force is generated becomes longer, causing decrease in decrease in the responsiveness of the differential limit force.

In contrast, according to the above first embodiment, clearances are formed in the rotation axis direction of the differential case 10, among at least part of the first disc spring 61, the first end washer 51, the first outer gear member 31 and the first inner gear member 32, the center washer 53, the second outer gear member 41 and the second inner gear member 42, the second end washer 52, and the second disc spring 62, between the bottom face 111c of the recess 111a of the first side wall part 111 and the bottom face 121c of the recess 121a of the second side wall part 121. That is to say, the amount of thermal expansion of the first outer gear member 31, the first inner gear member 32, the second outer gear member 41, and the second inner gear member 42 can be absorbed by the first disc spring 61 and the second disc spring 62, and a situation in which all clearances between the first side wall part 111 and the second side wall part 121 become closed off does not occur, and accordingly increase in the differential limit force due to thermal expansion of the gears in the differential case can be suppressed, while suppressing decrease in the responsiveness of the differential limit force.

Note that even in a case in which, for example, the axial-direction end faces 31c and 31d of the first outer gear member 31 come into contact with both the first end washer 51 and the center washer 53 respectively, or in a case in which the axial-direction end faces 32c and 32d of the first inner gear member 32 come into contact with both the first end washer 51 and the center washer 53 respectively, the above-described effect can be obtained as long as a clearance having a length in the rotation axis direction that is no smaller than that corresponding to a thickness T of the first disc spring 61 (see FIG. 4A) is formed between the bottom face 111c of the recess 111a of the first side wall part 111 and the first end washer 51. The same is true regarding the second side gear 4 side, as well.

### Second Embodiment

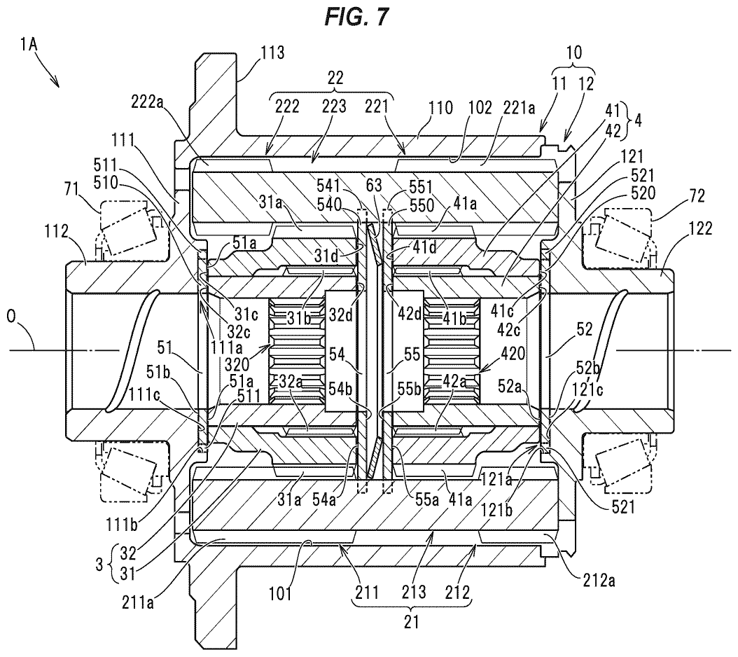

Next, a second embodiment of the present disclosure will be described with reference to FIG. 7, FIG. 8A, and FIG. 8B.

FIG. 7 is a cross-sectional view of a vehicle differential device 1A according to the second embodiment. FIG. 8A is a cross-sectional view of part of the vehicle differential device 1A at normal temperature. FIG. 8B is a cross-sectional view of part of the vehicle differential device 1A at high temperature.

In the first embodiment, a case has been described in which the first disc spring 61 is disposed between the first end washer 51 and the first side wall part 111, the second disc spring 62 is disposed between the second end washer 52 and the second side wall part 121, and one center washer 53 is disposed between the first side gear pair 3 and the second side gear pair 4. In the vehicle differential device 1A according to the second embodiment, an elastic member such as a disc spring or the like is disposed between neither the first end washer 51 and the first side wall part 111, nor between the second end washer 52 and the second side wall part 121, and instead of the center washer 53, two center washers 54 and 55, serving as third sliding members, are disposed between the first side gear pair 3 and the second side gear pair 4, and a disc spring 63 serving as an elastic member is disposed between these center washers 54 and 55. Other configurations of the vehicle differential device 1A are the same as those of the vehicle differential device 1 according to the first embodiment.

Hereinafter, of the two center washers 54 and 55, the center washer 54 on the first side gear pair 3 side will be referred to as first center washer 54, and the center washer 55 on the second side gear pair 4 side will be referred to as second center washer 55. The first center washer 54 has a body part 540 that has an annular shape and a plurality of projections 541 that is formed projecting outward from the body part 540. The second center washer 55 has a body part 550 that has an annular shape and a plurality of projections 551 that is formed projecting outward from the body part 550. The plurality of projections 541 and 551 of the first and second center washers 54 and 55 is engaged at the linking parts 213 and 223 of the first and second pinion gears 21 and 22, respectively, whereby relative rotation to the differential case 10 is restricted, and also the center washers 54 and 55 are movable relative to the differential case 10 in the rotation axis direction.

A face of the first center washer 54 facing the first side gear pair 3 side is a first sliding face 54a that slides against the axial-direction end face 31d of the first outer gear member 31 during driving, and slides against the axial-direction end face 32d of the first inner gear member 32 during coasting. A face of the second center washer 55 facing the second side gear pair 4 side is a second sliding face 55a that slides against the axial-direction end face 41d of the second outer gear member 41 during driving, and slides against the axial-direction end face 42d of the second inner gear member 42 during coasting.

The disc spring 63 is arrayed with the first center washer 54 and the second center washer 55 in the rotation axis direction of the differential case 10, and is disposed between a first abutting face 54b of the first center washer 54 that is a rear side of the first sliding face 54a, and a second abutting face 55b of the second center washer 55 that is a rear side of the second sliding face 55a. One end part 631 of the disc spring 63 in the rotation axis direction of the differential case 10 abuts the first abutting face 54b of the first center washer 54, and another end part 632 of the disc spring 63 abuts the second abutting face 55b of the second center washer 55.

The disc spring 63 biases the first center washer 54 toward the first side gear pair 3 side, and also biases the second center washer 55 toward the second side gear pair 4 side. Also, the disc spring 63 is compressed in the axial direction by thrust forces acting on the first outer gear member 31 and the second outer gear member 41 during driving, and is compressed in the axial direction by thrust forces acting on the first inner gear member 32 and the second inner gear member 42 during coasting.

As in the first embodiment, with the vehicle differential device 1A according to this second embodiment as well, amount of thermal expansion of the first outer gear member 31, the first inner gear member 32, the second outer gear member 41, and the second inner gear member 42 can be absorbed by the disc spring 63, and the distance between the first center washer 54 and the second center washer 55 is maintained at a distance that is longer than the thickness of the disc spring 63. This enables increase in the differential limit force due to thermal expansion of the gears in the differential case to be suppressed, while suppressing decrease in the responsiveness of the differential limit force.

### Additional Notes

Although the present disclosure has been described above based on the first and second embodiments, the disclosure according to the claims is not limited to these embodiments. It should also be noted that not all the combinations of features described in the embodiment are essential to means for solving the problem in the disclosure. Also, the present disclosure can be carried out modified as appropriate by omitting part of the configurations or adding or replacing configurations, without departing from the spirit and scope thereof. Furthermore, part of the configurations of the above-described plurality of embodiments can be combined with each other, and also can be modified as described below, for example.

In the above first embodiment, a case has been described in which the first disc spring 61 is disposed between the first end washer 51 and the first side wall part 111, and the second disc spring 62 is disposed between the second end washer 52 and the second side wall part 121, but one of the first disc spring 61 and the second disc spring 62 may be omitted. For example, in a case in which the first disc spring 61 is omitted, the first end washer 51 abuts the bottom face 111c of the recess 111a of the first side wall part 111, and the second disc spring 62 absorbs the amount of thermal expansion of the first outer gear member 31, the first inner gear member 32, the second outer gear member 41, and the second inner gear member 42. Also, in a case in which the second disc spring 62 is omitted, the second end washer 52 abuts the bottom face 121c of the recess 121a of the second side wall part 121, and the first disc spring 61 absorbs the amount of thermal expansion of the first outer gear member 31, the first inner gear member 32, the second outer gear member 41, and the second inner gear member 42. That is to say, the effects of the present disclosure can be obtained as long as at least one disc spring of the first disc spring 61 and the second disc spring 62 according to the first embodiment, and the disc spring 63 according to the second embodiment, is provided as an elastic member. Note that the elastic member is not limited to a disc spring, and a wave washer, a coil spring, or the like, for example, can be used.

Also, in the first and second embodiments, a case is described in which each pinion gear pair 2 is made up of a combination of two pinion gears (the first pinion gear 21 and the second pinion gear 22) having the same length in the axial direction, but this is not restrictive, and one pinion gear pair may be formed by combining one pinion gear with two pinion gears that are shorter in length than the one pinion gear, as proposed by the present applicant in JP 2020-94681 A, for example. In this case, a single pinion gear is used that has two gear parts, one large and one small, with different pitch circle diameters on one side and the other side of a longitudinal-direction middle part, with the two short pinion gears meshing with the smaller-diameter gear part thereof.

### REFERENCE SIGNS LIST

1, 1A VEHICLE DIFFERENTIAL DEVICE
10 DIFFERENTIAL CASE
100 RETAINING HOLE
110 CYLINDRICAL PART
111 FIRST SIDE WALL PART
2 PINION GEAR PAIR
21 FIRST PINION GEAR
22 SECOND PINION GEAR
3 FIRST SIDE GEAR PAIR
31 FIRST OUTER GEAR MEMBER
32 FIRST INNER GEAR MEMBER
4 SECOND SIDE GEAR PAIR
41 SECOND OUTER GEAR MEMBER
42 SECOND INNER GEAR MEMBER
51 FIRST END WASHER (FIRST SLIDING MEMBER)
52 SECOND END WASHER (SECOND SLIDING MEMBER)
53 CENTER WASHER (THIRD SLIDING MEMBER)
54 FIRST CENTER WASHER (THIRD SLIDING MEMBER)
55 SECOND CENTER WASHER (THIRD SLIDING MEMBER)
61 FIRST DISC SPRING (ELASTIC MEMBER)
62 FIRST DISC SPRING (ELASTIC MEMBER)
63 FIRST DISC SPRING (ELASTIC MEMBER)

1. A vehicle differential device, comprising:
a pinion gear pair including a first pinion gear and a second pinion gear that have helical teeth of which tooth traces are inclined with respect to an axial direction, and that are meshed with each other;
a first side gear pair including a first outer gear member that has a cylindrical shape and that meshes with the first pinion gear, and a first inner gear member that is disposed on an inner side of the first outer gear member, the first outer gear member and the first inner gear member being helically spline fitted with each other,
a second side gear pair including a second outer gear member that has a cylindrical shape and that meshes with the second pinion gear, and a second inner gear member that is disposed on an inner side of the second outer gear member, the second outer gear member and the second inner gear member being helically spline fitted with each other;
a differential case that includes a cylindrical part in which a retaining hole for rotatably accommodating the first pinion gear and the second pinion gear is formed, and first and second side wall parts;
a first sliding member that is disposed between the first side gear pair and the first side wall part;
a second sliding member that is disposed between the second side gear pair and the second side wall part;
a third sliding member that is disposed between the first side gear pair and the second side gear pair; and
an elastic member that is disposed arrayed with any one of the first to third sliding members, between the first side wall part and the second side wall part within the differential case in a rotation axis direction of the differential case, and that is elastically deformable in the rotation axis direction, wherein
the elastic member is compressed in the rotation axis direction by the first outer gear member and the second outer gear member, or the first inner gear member and the second inner gear member, both during driving, which is when torque in a forward direction of the vehicle is input to the differential case, and during coasting, which is when the vehicle is traveling forward under inertia, and
the first sliding member and the second sliding member are restricted from rotating relative to the differential case, and are also movable relative to the differential case in the rotation axis direction.

2. The vehicle differential device according to claim 1, wherein one face of the first sliding member in the rotation axis direction is a sliding face that frictionally slides against axial-direction end faces of each of the first outer gear member and the first inner gear member, and the elastic member is disposed between another face of the first sliding member in the rotation axis direction and the first side wall part.

3. The vehicle differential device according to claim 2, wherein one face of the second sliding member in the rotation axis direction is a sliding face that frictionally slides against axial-direction end faces of each of the second outer gear member and the second inner gear member, and the elastic member is disposed between another face of the second sliding member in the rotation axis direction and the second side wall part.

4. (canceled)

5. The vehicle differential device according to claim 1, wherein the vehicle differential device includes two of the third sliding members, and the elastic member is disposed between the two of the third sliding members.
